(19) United States
(12) Patent Application Publication
(10) Pub. No.: US 2011/0096057 A1
(43) Pub. Date: Apr. 28, 2011

(54) PLASMA DISPLAY APPARATUS

(76) Inventors: Seonghak Moon, Seoul (KR); Namjin Kim, Seoul (KR); Daejin Myoung, Seoul (KR); Byungsoo Song, Seoul (KR)

(21) Appl. No.: 12/995,734

(22) PCT Filed: Oct. 2, 2008
(86) PCT No.: PCT/KR08/05802

§ 371 Date: Dec. 2, 2010

(30) Foreign Application Priority Data
Jun. 11, 2008 (KR) 10-2008-00553
Jun. 25, 2008 (KR) 10-2008-0060142

(51) Int. Cl. G09G 3/28; G09G 5/00

(52) U.S. Cl. 345/211; 345/58; 345/60

(57) ABSTRACT

A plasma display apparatus is disclosed. The plasma display apparatus includes a plasma display panel that displays a left eye image and a right eye image before and after a crosstalk prevention period during a frame, a first driver that supplies a data signal for the left eye image and the right eye image to the plasma display panel, and a second driver that supplies a sustain signal to discharge cells of the plasma display panel selected by the supply of the data signal.

### TECHNICAL FIELD

Exemplary embodiments relate to a plasma display apparatus.

### BACKGROUND ART

A plasma display apparatus generally includes a plasma display panel displaying an image and a driver supplying a driving signal to the plasma display panel.

The plasma display panel includes discharge spaces surrounded by barrier ribs, and each discharge space is filled with a discharge gas. The driver supplies the driving signal to the discharge space, thereby generating a discharge required to display the image on the plasma display panel.

The driver supplies the driving signal to the plasma display panel during a reset period, an address period, and a sustain period. The driver supplies a reset signal for initializing a state of wall charges distributed inside the discharge space during the reset period, supplies a scan signal and a data signal for selecting the discharge space to be turned on during the address period, and supplies a sustain signal for emitting light from the selected discharge space during the sustain period. Hence, the image is displayed on the plasma display panel.

Studies have been actively carried out to improve the image quality of a three dimensional (3D) image displayed by the plasma display apparatus.

### DISCLOSURE OF INVENTION

### Technical Problem

The object of this invention is for improving the image quality of a three dimensional image.

### Technical Solution

A plasma display apparatus comprises a plasma display panel that displays a left eye image and a right eye image before and after a crosstalk prevention period during a frame, a first driver that supplies a data signal for the left eye image and the right eye image to the plasma display panel, and a second driver that supplies a sustain signal to discharge cells of the plasma display panel selected by the supply of the data signal.

A plasma display apparatus comprises a plasma display panel that displays a left eye image and a right eye image before and after a crosstalk prevention period during a frame, a first driver that supplies a data signal for the left eye image and the right eye image to the plasma display panel, a second driver that supplies a sustain signal to discharge cells of the plasma display panel selected by the supply of the data signal, a goggle that allows the left eye image and the right eye image to be respectively incident on a left eye and a right eye, and a control signal output unit that outputs a first control signal for turning on a left eye shutter of the goggle and a second control signal for turning on a right eye shutter of the goggle.

### Advantageous Effects

This invention improves the image quality of the three dimensional image by using a crosstalk prevention period.

### BRIEF DESCRIPTION OF THE DRAWINGS

FIG. 1 illustrates a plasma display apparatus according to an exemplary embodiment;

FIG. 2 illustrates driving signals of the plasma display apparatus;

FIG. 3 illustrates a subfield arrangement for a drive of the plasma display apparatus;

FIGS. 4 and 5 are diagrams for illustrating a light hold period of a phosphor;

FIG. 6 illustrates another subfield arrangement for a drive of the plasma display apparatus;

FIG. 7 illustrates another driving signal of the plasma display apparatus;

FIG. 8 illustrates an implementation of a reset signal and a subfield arrangement for a drive of the plasma display apparatus;

FIG. 9 illustrates another implementation of a reset signal and a subfield arrangement for a drive of the plasma display apparatus;

FIG. 10 illustrates another driving signal of the plasma display apparatus;

FIG. 11 illustrates another subfield arrangement for a drive of the plasma display apparatus;

FIG. 12 illustrates another subfield arrangement for a drive of the plasma display apparatus;

FIG. 13 illustrates another subfield arrangement for a drive of the plasma display apparatus;

FIG. 14 illustrates changes in a pause period depending on a frame for a drive of the plasma display apparatus;

FIG. 15 illustrates a pause period between frames for a drive of the plasma display apparatus;

FIG. 16 illustrates changes in a pause period depending on an average picture level (APL) for a drive of the plasma display apparatus;

FIG. 17 illustrates subfields arranged depending on weight values for a drive of the plasma display apparatus;

FIG. 18 illustrates subfields arranged depending weight values for a drive of the plasma display apparatus;

FIG. 19 illustrates a voltage supplied during a pause period for a drive of the plasma display apparatus;

FIG. 20 illustrates another implementation of the plasma display apparatus according to the exemplary embodiment;

FIG. 21 illustrates an arrangement of subfields for displaying a three dimensional (3D) image;

FIG. 22 illustrates a process for setting gray levels of a left eye image, a common image, and a right eye image;

FIG. 23 illustrates an arrangement of subfields in the plasma display apparatus according to the exemplary embodiment;

FIG. 24 illustrates another arrangement of subfields in the plasma display apparatus according to the exemplary embodiment;

FIG. 25 illustrates another arrangement of subfields in the plasma display apparatus according to the exemplary embodiment;

FIG. 26 illustrates another arrangement of subfields in the plasma display apparatus according to the exemplary embodiment;

FIG. 27 illustrates a common partial frame belonging to each of two frames;

FIG. 28 illustrates changes in first and second partial frames of each of different frames;

FIG. 29 illustrates another implementation of the plasma display apparatus according to the exemplary embodiment; and

FIG. 30 is a timing diagram for explaining an operation of a goggle shown in FIG. 29.

### BEST MODE FOR CARRYING OUT THE INVENTION

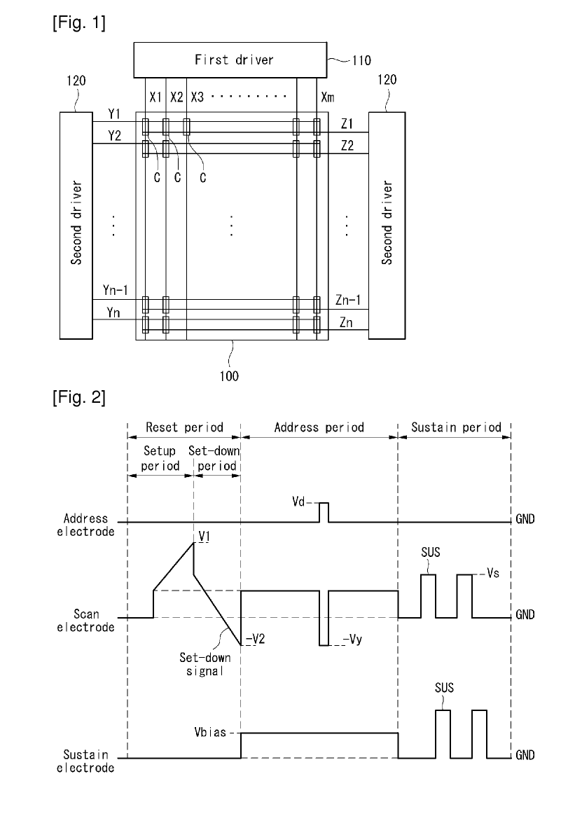

FIG. 1 shows a plasma display apparatus according to an exemplary embodiment. As shown in FIG. 1, the plasma display apparatus includes a plasma display panel 100, a first driver 110, and a second driver 120.

The plasma display panel 100 displays a left eye image and a right eye image before and after a crosstalk prevention period during a frame period. The plasma display panel 100 includes an upper panel (not shown) and a lower panel (not shown) that are coupled to be spaced apart from each other at a predetermined distance. The upper panel of the plasma display panel 100 includes scan electrodes Y1 to Yn and sustain electrodes Z1 to Zn positioned parallel to each other, and the lower panel of the plasma display panel 100 includes address electrodes X1 to Xm crossing the scan electrodes Y1 to Yn and the sustain electrodes Z1 to Zn. A discharge cell C is formed at each crossing of the scan electrodes Y1 to Yn, the sustain electrodes Z1 to Zn, and the address electrodes X1 to Xm. Phosphors are coated on the discharge cells C to emit light during a sustain discharge.

The first driver 110 supplies a data signal for the left eye image and the right eye image to the address electrodes X1 to Xm.

The second driver 120 supplies a sustain signal to the discharge cell C selected by the supply of the data signal.

The crosstalk prevention period means a period capable of reducing a crosstalk phenomenon in which one of the left eye image or the right eye image affects the other image. The crosstalk prevention period is arranged between a period during which the left eye image is displayed and a period during which the right eye image is displayed.

In the exemplary embodiment, the crosstalk prevention period may be a pause period or a period during which a common image is displayed. In other words, because the left eye image and the right eye image are displayed before and after the pause period or the display period of the common image, the crosstalk phenomenon in which one of the left eye image or the right eye image affects the other image decreases.

FIG. 2 illustrates driving signals of the plasma display apparatus.

The second driver 120 supplies a setup signal, that gradually rises from a reference voltage to a first voltage V1, to the scan electrodes Y1 to Yn during a setup period of a reset period, thereby forming a sufficient amount of wall charges on the scan electrodes Y1 to Yn. The reference voltage may be a ground level voltage GND.

The second driver 120 supplies a set-down signal, that gradually falls to a second voltage V2, to the scan electrodes Y1 to Yn during a set-down period of the reset period. Hence, a portion of the wall charges formed during the setup period is erased, and a proper amount of wall charges remain on the scan electrodes Y1 to Yn to the extent that an address discharge can stably occur. The set-down signal may be supplied or may not be supplied depending on subfields.

During an address period, the second driver 120 supplies a scan signal falling to a scan voltage −Vy to the scan electrodes Y1 to Yn, and the first driver 110 supplies a data signal, that is synchronized with the scan signal to rise to a data voltage Vd, to the address electrodes X1 to Xm. Hence, an address discharge occurs, thereby selecting the discharge cells to be turned on.

During the address period, the second driver 120 supplies a sustain bias voltage Vbias to the sustain electrodes Z1 to Zn so that the address discharge smoothly occurs between the scan electrodes Y1 to Yn and the address electrodes X1 to Xm. The sustain bias voltage Vbias may be supplied during the set-down period and the address period.

During a sustain period, the second driver 120 supplies sustain signals SUS, that allows a voltage difference between the scan electrodes Y1 to Yn and the sustain electrodes Z1 to Zn to be equal to a sustain voltage Vs, to the scan electrodes Y1 to Yn and the sustain electrodes Z1 to Zn so as to emit light from the selected discharge cells. Hence, light is emitted from the discharge cells selected during the address period.

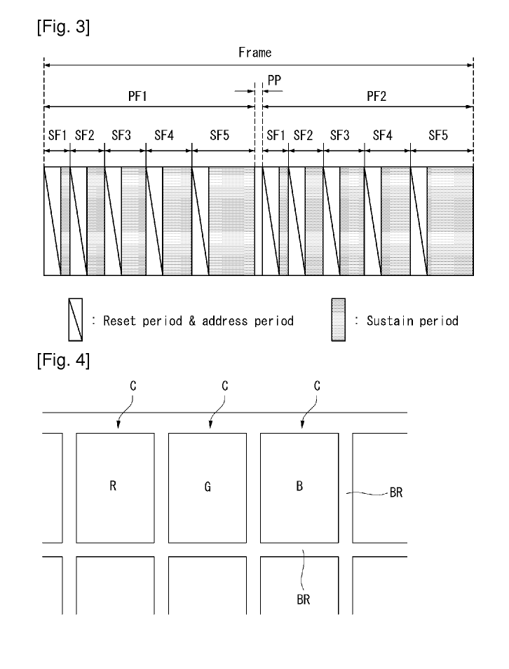

FIG. 3 illustrates a subfield arrangement for a drive of the plasma display apparatus. As shown in FIG. 3, the left eye image and the right eye image are displayed during a frame including a first partial frame PF1 and a second partial frame PF2 so as to display a three dimensional (3D) image. The plasma display panel 100 displays the left eye image and the right eye image before and after a pause period of a frame. The second driver 120 supplies driving signals for the left eye image and the right eye image. One of the left eye image or the right eye image is displayed before the pause period, and the other image is displayed after the pause period.

Because the pause period is arranged between a display period of the left eye image and a display period of the right eye image, the crosstalk caused by a light hold period of the phosphor coated on the discharge cell can be prevented.

FIGS. 4A and 4B are diagrams for illustrating the light hold period of the phosphor. As shown in FIG. 4, the phosphor, for example, an R phosphor emitting red light, a G phosphor emitting green light, and a B phosphor emitting blue light are coated on the discharge cells C partitioned by barrier ribs BR.

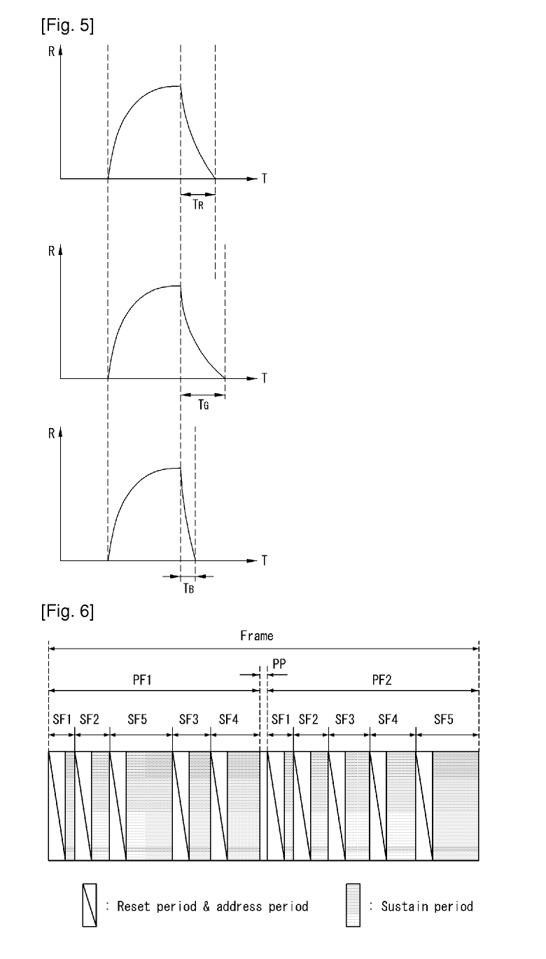

The R phosphor, the G phosphor, and the B phosphor are different from one another in the light hold period that ranges from a time when light is maximumly emitted to a time when the emission of light stops. As shown in FIG. 5, a light hold period TG of the G phosphor is the longest, and a light hold period TB of the B phosphor is the shortest. For example, the light hold periods of the R, G, and B phosphors may be approximately 4 ms, 5 ms, and 1 ms, respectively.

As the light hold period of the phosphor becomes longer, the possibility of causing the crosstalk increases. For example, when the left eye image is displayed and then the right eye image is displayed, the crosstalk in which green light of the left eye image is seen to overlap the right eye image, may occur. The left eye image and the right eye image have to be dividedly displayed so as to improve the image quality of the 3D image.

Accordingly, as shown in FIG. 3, because an image is not displayed during a pause period pp between the first partial frame PF1 during which one of the left eye image or the right eye image is displayed and the second partial frame PF2 during which the other image is displayed, light emitted from the phosphor whose the light hold period is long does not overlap the image displayed during the second partial frame PF2.

A length of the pause period pp may be equal to or smaller than a maximum value of lengths of light hold periods of the phosphors and may be equal to or larger than a minimum value of the lengths of the light hold periods of the phosphors. If the length of the pause period pp is equal to or more than the shortest light hold period, a reduction width in luminances of the left eye image and the right eye image can be reduced by the pause period pp. If the length of the pause period pp is equal to or less than the longest light hold period, the possibility of causing the crosstalk decreases. Accordingly, when the light hold periods of the R, G, and B phosphors are 4 ms, 5 ms, and 1 ms, respectively, the length of the pause period pp may be 1 ms to 5 ms.

The length of the pause period pp may be equal to or longer than the shortest light hold period and may be shorter than 50% of the longest light hold period. For example, when the light hold periods of the R, G, and B phosphors are 4 ms, 5 ms, and 1 ms, respectively, the length of the pause period pp may be smaller than 2.5 ms. When the pause period pp is smaller than 2.5 ms, the first partial frame PF1 and the second partial frame PF2 can be secured while the crosstalk is prevented. Hence, the 3D image can be stably displayed.

When the first partial frame PF1 is arranged before the pause period pp and the second partial frame PF2 is arranged after the pause period pp, a weight value of a subfield adjacent to the pause period pp among subfields belonging to the first partial frame PF1 may be smaller than a maximum value of weight values of other subfields except the subfield adjacent to the pause period pp.

For example, as shown in FIG. 6, if the first partial frame PF1 includes 1st to 5th subfields SF1 to SF5, a weight value of the 4th subfield SF4 adjacent to the pause period pp is smaller than a weight value of the 5th subfield SF5 of the first partial frame PF1.

When the weight value of the subfield of the first partial frame PF1 adjacent to the pause period pp is equal to the maximum weight value of the subfields of the first partial frame PF1, the amount of light emitted from the plasma display panel during the adjacent subfield is maximized. Therefore, the possibility of causing the crosstalk between an image displayed during the first partial frame PF1 and an image displayed during the second partial frame PF2 increases.

Accordingly, if the weight value of the subfield of the first partial frame PF1 adjacent to the pause period pp is not equal to the maximum weight value of the first partial frame PF1, the possibility of causing the crosstalk between an image displayed during the first partial frame PF1 and an image displayed during the second partial frame PF2 decreases. Hence, the image quality of the 3D image is improved.

In FIG. 6, the first partial frame PF1 and the second partial frame PF2 include the same subfields SF1 to SF5, but the first partial frame PF1 and the second partial frame PF2 may include different subfields. For example, the first partial frame PF1 may include 1st to 5th subfields, and the second partial frame PF2 may include 1st to 4th subfields and a 6th subfield having a weight value larger than a weight value of the 5th subfield.

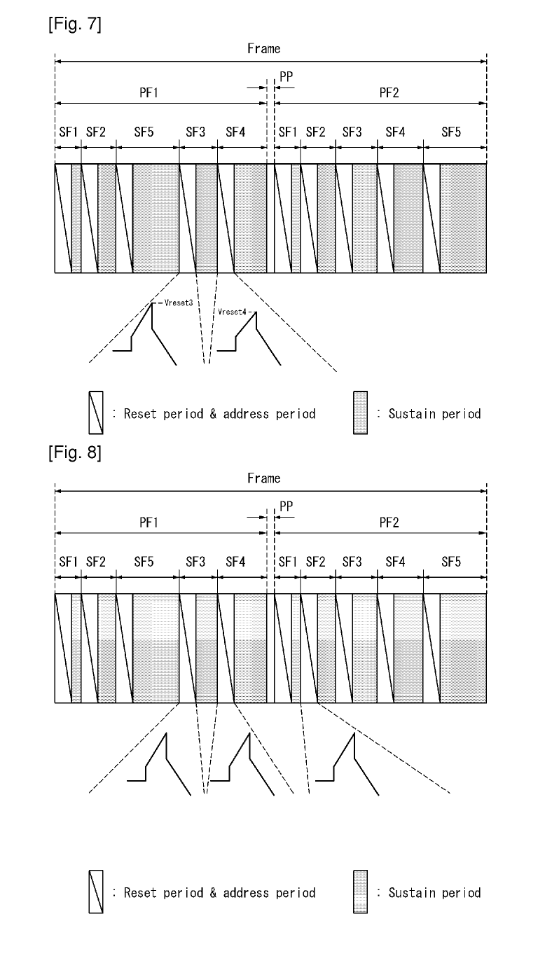

As shown in FIG. 7, a highest voltage of a reset signal supplied in the subfield of the first partial frame PF1 adjacent to the pause period pp may be smaller than highest voltages of reset signals supplied in the other subfields except the subfield adjacent to the pause period pp. For example, a highest voltage Vreset4 of a reset signal supplied in the 4th subfield SF4 adjacent to the pause period pp is smaller than a highest voltage Vreset3 of a reset signal supplied in the 3rd subfield SF3 of the first partial frame PF1. Hence, because the amount of light emitted during a reset period of the subfield adjacent to the pause period pp decreases, occurrence of the crosstalk between the image displayed during the first partial frame PF1 and the image displayed during the second partial frame PF2 decreases.

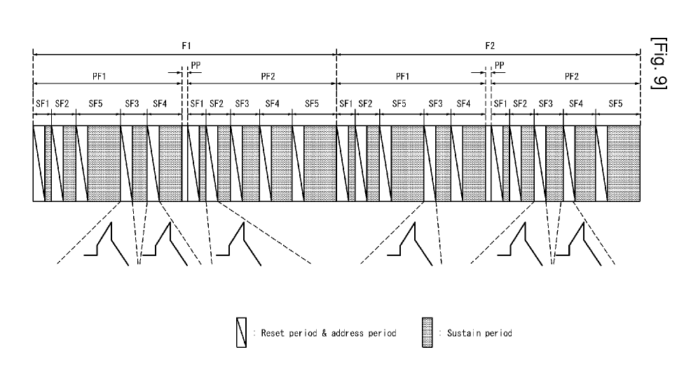

As shown in FIG. 8, the number of setup signals supplied during the first partial frame PF1 may be different from the number of setup signals supplied during the second partial frame PF2. In other words, when the subfield SF5 having a largest weight value in the first partial frame PF1 is not adjacent to the pause period pp, a state of wall charges distributed in the discharge cells may be unstable if a small number of discharge cells is addressed during the subfield SF5. Hence, an erroneous discharge may occur in the 3rd and 4th subfields SF3 and SF4 following the subfield SF5. Accordingly, a state of wall charges distributed in the discharge cells can be stabilized by supplying the setup signals in the 3rd and 4th subfields SF3 and SF4 or supplying the plurality of setup signals in the 3rd subfield SF3 or the 4th subfield SF4. Next, the setup signals, whose the number is smaller than the number of setup signals supplied during the first partial frame PF1, may be supplied in the second partial frame PF2 so as to improve a contrast characteristic.

As shown in FIG. 9, when the number of setup signals supplied during a first partial frame PF1 of a first frame F1 is more than the number of setup signals supplied during a second partial frame PF2 of the first frame F1 so as to stabilize the distribution of the wall charges, a contrast characteristic of the first partial frame PF1 is less than a contrast characteristic of the second partial frame PF2.

Hence, if the number of setup signals supplied during a first partial frame PF1 of a second frame F2 is more than the number of setup signals supplied during a second partial frame PF2 of the second frame F2, the contrast characteristics of the first partial frame PF1 and the second partial frame PF2 are not balanced.

Accordingly, the contrast characteristics of the first partial frame PF1 and the second partial frame PF2 can be balanced by allowing the number of setup signals supplied during a first partial frame PF1 of the second frame F2 to be less than the number of setup signals supplied during the second partial frame PF2 of the second frame F2.

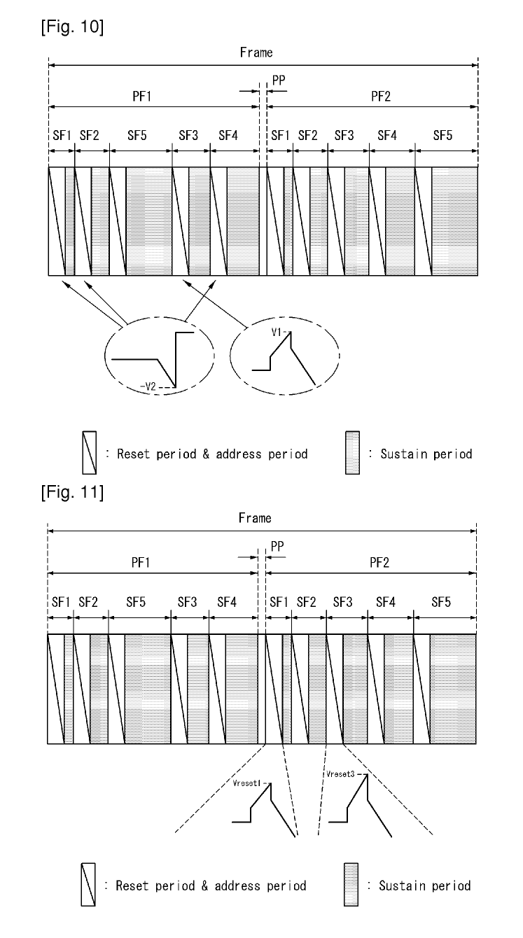

As shown in FIG. 10, a setup signal with a gradually rising voltage and a set-down signal with a gradually falling voltage may be supplied to at least one of subfields SF1, SF2, SF3 and SF5 except a subfield SF4 adjacent to a pause period pp in the subfields SF1 to SF5 of a first partial frame PF1. As described above, if a small number of discharge cells are addressed during the subfield SF5 having a largest weight value in the first partial frame PF1, a state of the wall charges distributed in the discharge cells is unstable. Therefore, the state of the wall charges distributed in the discharge cells can be stable by supplying the setup signal with the gradually rising voltage and the set-down signal with the gradually falling voltage to at least one of the subfields SF1, SF2, SF3 and SF5 except the subfield SF4 adjacent to the pause period pp. After the state of the wall charges distributed in the discharge cells is stable, the set-down signal may be supplied to the subfield SF4 adjacent to the pause period pp, thereby reducing the amount of light emitted during a reset period of the subfield SF4. Hence, the crosstalk between an image displayed during the first partial frame PF1 and an image displayed during the second partial frame PF2 decreases, and the contrast characteristic is improved.

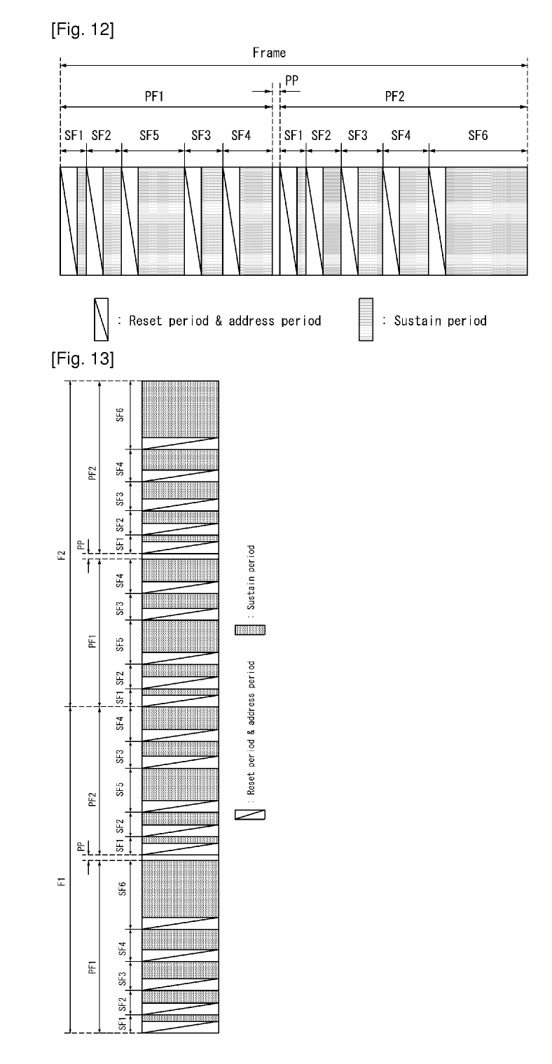

FIG. 11 illustrates another subfield arrangement for a drive of the plasma display apparatus. A highest voltage of a reset signal supplied in a subfield adjacent to a pause period pp in a second partial frame PF2 may be smaller than highest voltages of reset signals supplied in other subfields except the subfield adjacent to the pause period pp. For example, as shown in FIG. 11, a highest voltage Vreset1 of a reset signal supplied in a 1st subfield SF1 adjacent to the pause period pp in the second partial frame PF2 is smaller than a highest voltage Vreset3 of a reset signal supplied in a 3rd subfield SF3 of the second partial frame PF2. Hence, a contrast characteristic of the subfield adjacent to the pause period pp in the second partial frame PF2 is improved, and light emitted by a sustain discharge remarkably appears during the subfield adjacent to the pause period pp in the second partial frame PF2. Accordingly, an influence of light emitted during a first partial frame PF1 on an image displayed during the second partial frame PF2 decreases, and the crosstalk decreases.

As shown in FIG. 12, the number of sustain signals supplied during a first partial frame PF1 may be different from the number of sustain signals supplied during a second partial frame PF2. More specifically, a period length of the first partial frame PF1 may be shorter than a period length of the second partial frame PF2. Hence, the amount of light of an image displayed prior to a pause period pp decreases, and crosstalk decreases.

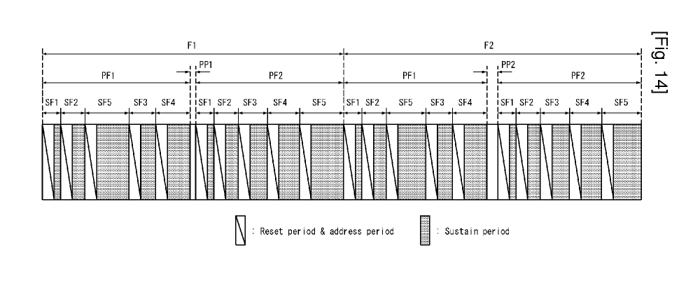

As shown in FIG. 13, a period length of a first partial frame PF1 of a frame Fl may be longer than a period length of a second partial frame PF2 of the frame Fl, and a period length of a first partial frame PF1 of another frame F2 may be smaller than a period length of a second partial frame PF2 of the frame F2. The frame F1 may or may not be adjacent to the frame F2. The frame F1 may be prior to the frame F2 in time order, or the frame F1 may follow the frame F2.

In case the first partial frames PF1, whose the period length is shorter than the period length of the second partial frame PF2, are successively arranged, because the amount of light of images displayed in the first partial frames PF1 is continuously less than the amount of light of an image displayed in the second partial frames PF2, the image whose the image quality is relatively reduced is continuously displayed. As a result, the image quality of the entire 3D image may be reduced. However, as shown in FIG. 13, when the period length of the first partial frame PF1 and the period length of the second partial frame PF2 change depending on the frame, a reduction in the image quality is prevented.

As shown in FIG. 14, when the plasma display panel displays a left eye image and a right eye image in each of a first frame F1 and a second frame F2, a length of a pause period pp1 of the first frame F1 may be different from a length of a pause period pp2 of the second frame F2. The pause periods pp1 and pp2 are a period during which an image is not displayed. Therefore, in case the lengths of the pause periods pp1 and pp2 are constant, a luminance of the image may be reduced and the quality of the entire 3D image may be reduced. In the present exemplary embodiment, because the length of the pause period changes depending on the frame, a reduction in the image luminance can be prevented while the occurrence of crosstalk decreases. The first frame F1 may or may not be adjacent to the second frame F2. The first frame F1 may be prior to the second frame F2 in time order, or the first frame F1 may follow the second frame F2.

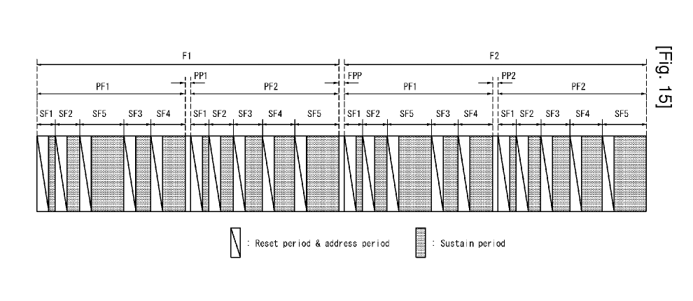

As shown in FIG. 15, when the plasma display panel displays a left eye image and a right eye image in each of a first frame F1 and a second frame F2, an image is not displayed during a frame pause period FPP between the first frame F1 and the second frame F2. Hence, the occurrence of crosstalk decreases between an image in a second partial frame PF2 of the first frame F1 and an image in a first partial frame PF1 of the second frame F2 decreases.

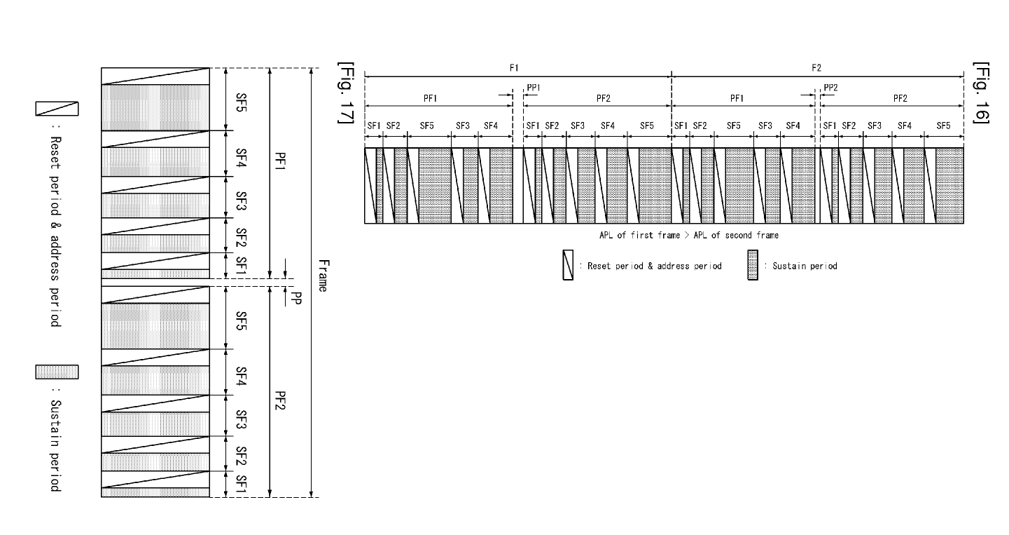

As shown in FIG. 16, when the plasma display panel displays a left eye image and a right eye image in each of a first frame F1 and a second frame F2, if an average picture level (APL) in the first frame F1 is larger than an APL in the second frame F2, a length of a pause period pp1 of the first frame F1 may be shorter than a length of a pause period pp2 of the second frame F2.

In other words, if the APL in the first frame F1 is larger than the APL in the second frame F2, the number of sustain signals assigned in the first frame F1 is smaller than the number of sustain signals assigned in the second frame F2. Accordingly, a luminance of an image in the first frame F1 is reduced, and thus the length of the pause period pp1 of the first frame F1 may be shorter than the length of the pause period pp2 of the second frame F2.

As described above, because the length of the pause period changes depending on the APL of the frame, a reduction in a luminance of the 3D image caused by a reduction in a length of a sustain period can be prevented while crosstalk of the 3D image is prevented.

The first frame F1 may or may not be adjacent to the second frame F2. The first frame F1 may be prior to the second frame F2 in time order, or the first frame F1 may follow the second frame F2.

As shown in FIG. 17, when a first partial frame PF1 and a second partial frame PF2 are arranged before and after a pause period pp, respectively, subfields belonging to the first partial frame PF1 and subfields belonging to the second partial frame PF2 may be arranged in decreasing order of weight values. Because a weight value of a 1st subfield SF1 of the first partial frame PF1 adjacent to the pause period pp is smaller than weight values of other subfields SF2 to SF5 of the first partial frame PF1, crosstalk is prevented. The subfields belonging to the first partial frame PF1 and the subfields belonging to the second partial frame PF2 may be the same as or different from each other.

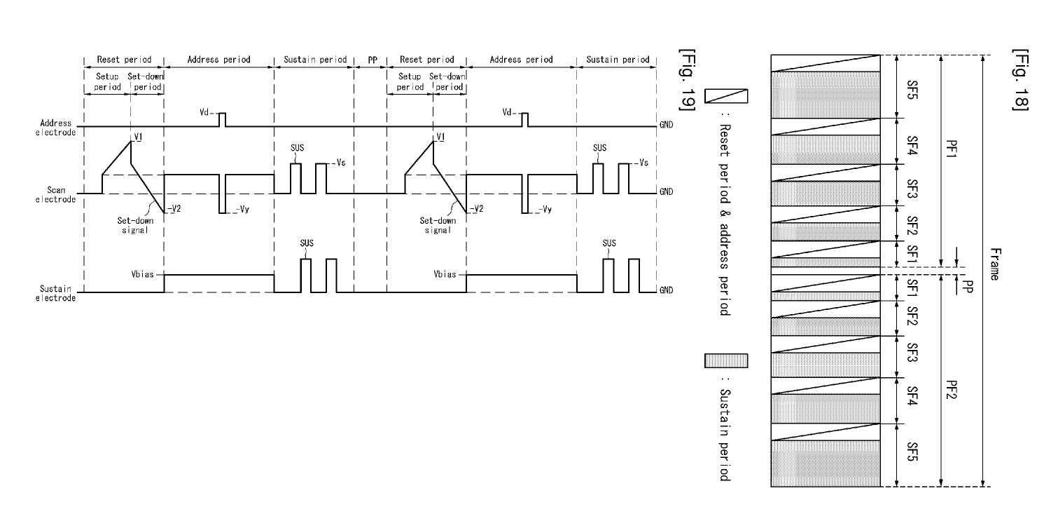

As shown in FIG. 18, when a first partial frame PF1 and a second partial frame PF2 are arranged before and after a pause period pp, respectively, subfields belonging to the first partial frame PF1 may be arranged in decreasing order of weight values, and subfields belonging to the second partial frame PF2 may be arranged in increasing order of weight values. Similar to the description of FIG. 17, because a weight value of a 1st subfield SF1 of the first partial frame PF1 adjacent to the pause period pp is smaller than weight values of other subfields SF2 to SF5 of the first partial frame PF1, crosstalk is prevented. The subfields belonging to the first partial frame PF1 and the subfields belonging to the second partial frame PF2 may be the same as or different from each other.

As shown in FIG. 19, the second driver 120 supplies a ground level voltage GND to the electrodes of the plasma display apparatus during a pause period pp. Hence, an image is not displayed during the pause period pp.

Because a specific voltage except the ground level voltage GND is not supplied to the electrodes of the plasma display apparatus during the pause period pp, the image is not displayed during the pause period pp.

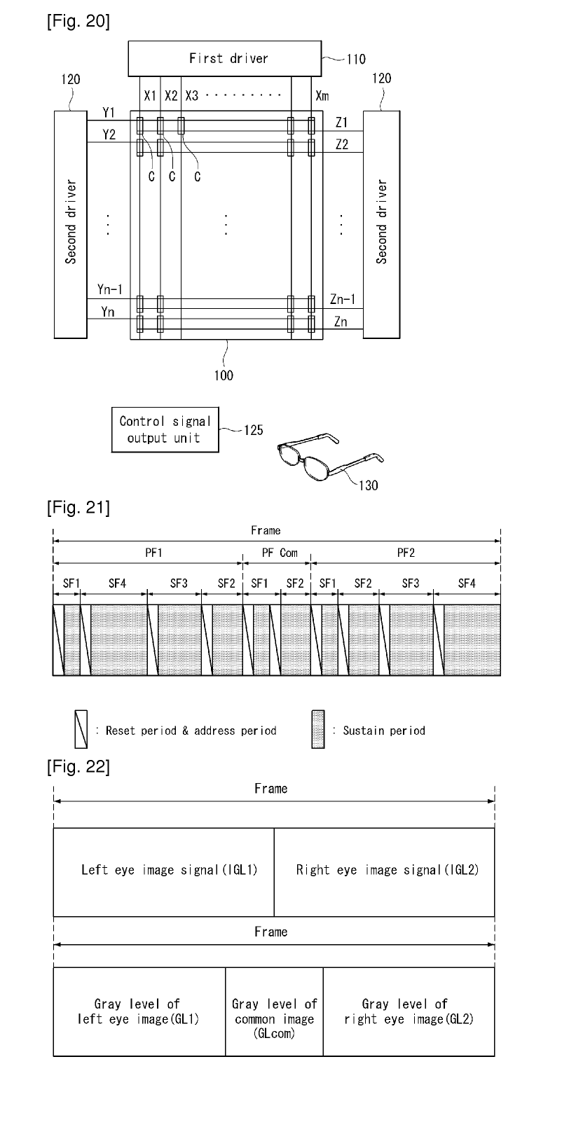

As shown in FIG. 20, the plasma display apparatus may further include a control signal output unit 125 outputting a control signal of a goggle 130 used to see a 3D image. The control signal output unit 125 allows one of a left eye image or a right eye image to be incident on one eye through one shutter (not shown) of the goggle 130 and then allows the other image to be incident on the other eye through the other shutter (not shown) of the goggle 130 in response to the control signal output by the control signal output unit 125. The control signal output unit 125 may output the control signal during a pause period. In case the control signal is output during a period other than the pause period, the shutter of the goggle 130 may be early closed or late closed. Hence, the quality of the 3D image may be reduced.

A reason to use a period during which a common image is displayed as a crosstalk prevention period is described below.

FIG. 21 illustrates an arrangement of subfields for displaying a 3D image. As shown in FIG. 21, a left eye image signal and a right eye image signal are input during a frame. The first driver 110 supplies left eye image data, right eye image data, and data of a common image between a left eye image and a right eye image during the frame.

The frame includes a first partial frame during which one of the left eye image or the right eye image is displayed, a common partial frame during which the common image is displayed, and a second partial frame during which the other of the left eye image or the right eye image is displayed. The first partial frame, the common partial frame, and the second partial frame are sequentially arranged.

The left eye image and the right eye image are respectively incident on a left eye and a right eye, and the common image is incident on the left eye and the right eye. The crosstalk phenomenon in which the image displayed prior to the common image affects the image displayed after the common image decreases, and the quality of the 3D image us improved.

Gray levels of the left eye image, the common image, and the right eye image is described below.

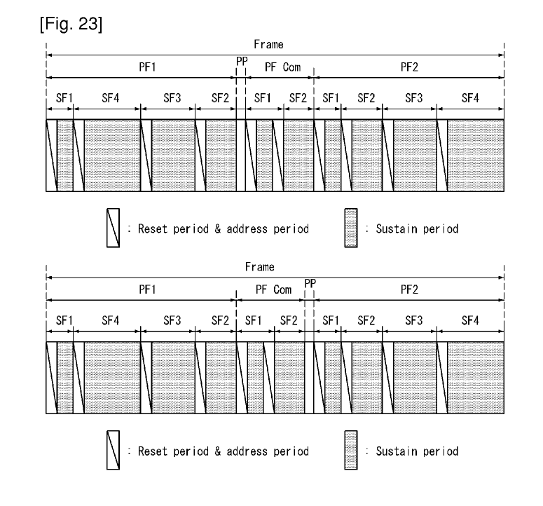

FIG. 22 illustrates a process for setting gray levels of a left eye image, a common image, and a right eye image. As shown at the top of FIG. 22, a left eye image signal and a right eye image signal are input during a frame. In FIG. 22, the left eye image signal is input, and then the right eye image signal is input. However, the right eye image signal may be input prior to the left eye image signal.

Common image data corresponds to a portion of a gray level of the left eye image signal and a portion of a gray level of the right eye image signal. For example, when a gray level of a left eye image signal IGL1 and a gray level of a right eye image signal IGL2 are each 100 and a gray level GL1 of a left eye image and a gray level GL2 of a right eye image are each 75, a gray level of a common image is 50. In other words, a gray level GLcom (=50) of the common image corresponds a portion (=25) of the gray level of the left eye image signal IGL1 and a portion (=25) of the gray level of the right eye image signal IGL2.

The first driver 110 supplies the common image data, left eye image data, and right eye image data to the plasma display panel 100.

As described above, because the common image is displayed between the left eye image and the right eye image, the crosstalk phenomenon in which the image displayed prior to the common image affects the image displayed after the common image decreases.

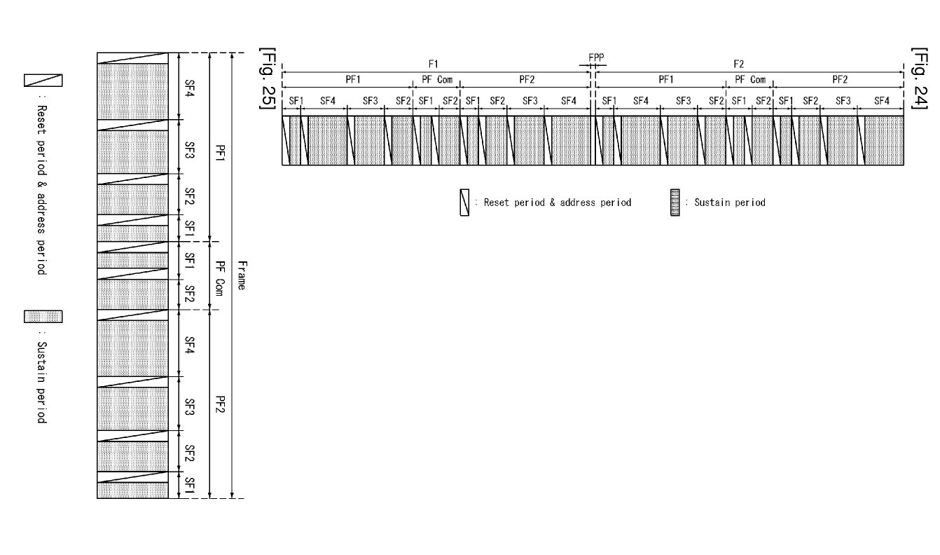

FIG. 23 illustrates an arrangement of subfields in the plasma display apparatus according to the exemplary embodiment. As shown in FIG. 23, a frame sequentially includes a first partial frame PF1 during which one of a left eye image or a right eye image is displayed, a common partial frame PFcom during which a common image is displayed, and a second partial frame PF2 during which the other of the left eye image or the right eye image is displayed.

A pause period pp may be arranged in at least one of an interval between the first partial frame PF1 and the common partial frame PFcom or an interval between the second partial frame PF2 and the common partial frame PFcom. During the pause period pp, a voltage having a constant level like the ground level voltage is supplied to the electrodes of the plasma display panel. Hence, the left eye image, the right eye image, and the common image are not displayed during the pause period pp.

In case the frame includes the pause period pp, the crosstalk phenomenon, in which the image displayed prior to the common partial frame PFcom affects the image displayed after the common partial frame PFcom, decreases.

The pause period may be arranged between frames. More specifically, as shown in FIG. 24, a frame pause period FPP may be arranged between frames F1 and F2 each including a first partial frame PF1, a common partial frame PFcom, and a second partial frame PF2. Hence, the crosstalk phenomenon, in which an image displayed during the second partial frame PF2 of the frame F1 affects an image displayed during the first partial frame PF1 of the frame F2, decreases.

As shown in FIG. 25, a frame sequentially includes a first partial frame PF1 during which one of a left eye image or a right eye image is displayed, a common partial frame PFcom during which a common image is displayed, and a second partial frame PF2 during which the other of the left eye image or the right eye image is displayed. In subfields SF4, SF3, SF2, and SF1 belonging to the first partial frame PF1, a weight value of the subfield SF1 of the first partial frame PF1 adjacent to subfields SF1 and SF2 belonging to the common partial frame PFcom may be smaller than weight values of the other subfields SF4, SF3 and SF2 of the first partial frame PF1.

As the weight value of the subfield adjacent to the common partial frame PFcom increases, the possibility of causing crosstalk increases. In other words, if the weight value of the subfield adjacent to the common partial frame PFcom is large, the possibility of causing crosstalk increases because the amount of light emitted just before the common partial frame PFcom is likely to increase. Accordingly, when the weight value of the subfield adjacent to the common partial frame PFcom is smaller than a largest weight value, the possibility of causing crosstalk decreases.

A weight value of a last subfield among subfields SF4, SF3, SF2, and SF1 belonging to the second partial frame PF2 may smaller than a maximum value of weight values of other subfields except the last subfield of the second partial frame PF2. For example, as shown in FIG. 25, a weight value of the last subfield SF1 of the second partial frame PF2 may smaller than a largest weight value of the subfield SF4 of the second partial frame PF2.

As described above, a reason why the weight value of the last subfield of the second partial frame PF2 is smaller than the maximum value of the weight values of the other subfields of the second partial frame PF2 is to prevent the occurrence of crosstalk of a left eye image or a right eye image displayed during a first partial frame PF1 of a frame following the second partial frame PF2.

As shown in FIG. 25, the subfields constituting each of the first partial frame PF1, the common partial frame PFcom, and the second partial frame PF2 may be arranged in decreasing order of weight values. More specifically, the subfields SF4, SF3, SF2, and SF1 of the first partial frame PF1 may be arranged in the order named, the subfields SF1 and SF2 of the common partial frame PFcom may be arranged in the order named, and the subfields SF4, SF3, SF2, and SF1 of the second partial frame PF2 may be arranged in the order named.

Because the weight value of the subfield SF1 of the first partial frame PF1 adjacent to the common partial frame PFcom corresponds to a minimum weight value of the subfields of the first partial frame PF1, and the weight value of the subfield SF1 of the common partial frame PFcom adjacent to the first partial frame PF1 corresponds to a maximum weight value of the subfields of the common partial frame PFcom, the occurrence of crosstalk is prevented.

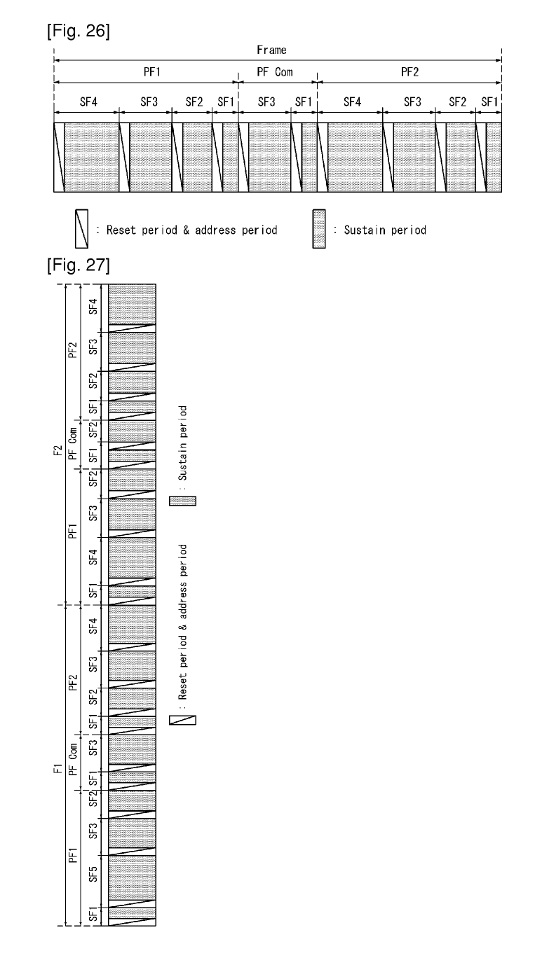

As shown in FIG. 26, a frame sequentially includes a first partial frame PF1 during which one of a left eye image or a right eye image is displayed, a common partial frame PFcom during which a common image is displayed, and a second partial frame PF2 during which the other of the left eye image or the right eye image is displayed.

Weight values of subfields SF3 and SF1 constituting the common partial frame PFcom are smaller than a maximum value (i.e., a weight value of a subfield SF4) of weight values of subfields SF4, SF3, SF2, and SF1 constituting the first partial frame PF1 and a maximum value (i.e., a weight value of a subfield SF4) of weight values of subfields SF4, SF3, SF2, and SF1 constituting the second partial frame PF2. The weight values of the subfields SF3 and SF1 of the common partial frame PFcom are equal to or larger than a minimum value (i.e., the weight value of the subfield SF1) of the weight values of the subfields SF4, SF3, SF2, and SF1 of the first partial frame PF1 and a minimum value (i.e., the weight value of the subfield SF1) of the weight values of the subfields SF4, SF3, SF2, and SF1 of the second partial frame PF2.

Because the weight values of the subfields SF3 and SF1 of the common partial frame PFcom are smaller than the largest weight value of the first partial frame PF1 and the largest weight value of the second partial frame PF2, a reduction in the image quality of the left eye image or the right eye image caused by the common image is prevented while the occurrence of crosstalk is prevented. In other words, if the weight values of the subfields of the common partial frame PFcom are larger than the largest weight value of the first partial frame PF1 and the largest weight value of the second partial frame PF2, a luminance of the common image may excessively increase and may affect the left eye image or the right eye image. Hence, the image quality of a 3D image may be reduced.

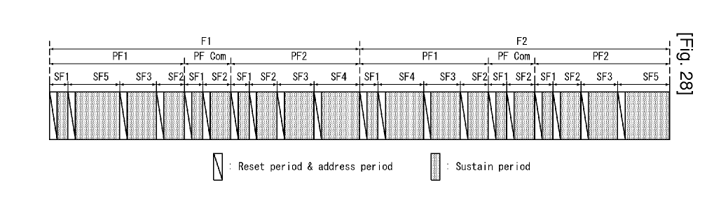

As shown in FIG. 27, lengths of periods, during which common images are displayed, in each of at least two frames F1 and F2 of a plurality of frames may be different from each other. In other words, a length of a common partial frame PFcom1 belonging to the frame F1 may be different from a length of a common partial frame PFcom2 belonging to the frame F2. The two frames F1 and F2 may or may not be adjacent to each other.

For example, if a first partial frame PF1 includes subfields having large weight values, it is a great likelihood of the occurrence of crosstalk because a luminance of an image displayed during the first partial frame PF1 has a large value. However, if the length of the common partial frame increases, the occurrence of crosstalk can decrease even if the luminance of the image displayed during the first partial frame PF1 has a large value. Further, if a first partial frame PF1 includes subfields having small weight values, it is a small likelihood of the occurrence of crosstalk because a luminance of an image displayed during the first partial frame PF1 has a small value. Accordingly, if the length of the common partial frame decreases, the occurrence of crosstalk can decrease and a clear image can be displayed because the number of sustain signals to be assigned to the first partial frame PF1 may increase.

In case an image is displayed during frames of which a length of a first partial frame is longer than a length of a second partial frame, a luminance of an image displayed during the first partial frames is continuously larger than a luminance of an image displayed during the second partial frames. Hence, the image quality of a 3D image may be reduced. To solve the above-described problem, as shown in FIG. 28, in a frame F1, a length of a first partial frame PF1 may be longer than a length of a second partial frame PF2. In a frame F2 following the frame F1, a length of a first partial frame PF1 may be shorter than a length of a second partial frame PF2. Because the lengths of the first partial frames PF1 are not continuously shorter or longer than the lengths of the second partial frames PF2 in the above frame arrangement, a reduction in the image quality of a 3D image can be prevented.

In the exemplary embodiment, the length of the common partial frame PFcom may be shorter than the lengths of the first partial frame PF1 and the second partial frame PF2. If the length of the common partial frame PFcom is longer than the length of the first partial frame PF1 or the second partial frame PF2, the image quality may be reduced because the amount of light emitted during the first partial frame PF1 or the second partial frame PF2 decreases. Therefore, when the length of the common partial frame PFcom is shorter than the length of the first partial frame PF1 or the second partial frame PF2, a reduction in the image quality can be prevented.

In the exemplary embodiment, the number of subfields constituting the common partial frame PFcom may be smaller than the number of subfields constituting the first partial frame PF1 and the number of subfields constituting the second partial frame PF2. Hence, a reduction in the amount of light emitted during the first partial frame PF1 or the second partial frame PF2 can be prevented, and a reduction in the image quality can be prevented.

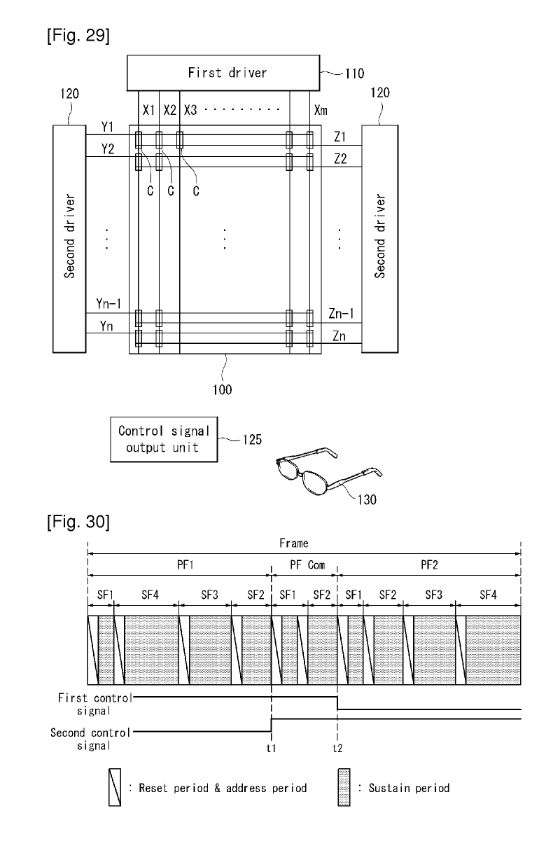

FIG. 29 illustrates another implementation of the plasma display apparatus according to the exemplary embodiment. As shown in FIG. 29, the plasma display apparatus includes a goggle 130 that allows a left eye image and a right eye image to be respectively incident on a left eye and a right eye and allows a common image to be incident on the left eye and the right eye.

The goggle 130 may include two shutters (not shown). One of the left eye image or the right eye image is incident on one of both eyes through the one open shutter, and then the common image is incident on the both eyes through the two open shutters. Next, one of the two shutters is closed and the other shutter remains in an open state. Next, the other of the left eye image or the right eye image is incident on the other eye through the one open shutter. Hence, a 3D image, in which the occurrence of crosstalk decreases, is displayed.

The plasma display apparatus includes a control signal output unit 125. The control signal output unit 125 outputs a first control signal for turning on one shutter of the goggle 130 and a second control signal for turning on the other shutter of the goggle 130 during a common partial frame so that the common image passes through the two shutters.

As shown in FIG. 30, the control signal output unit 125 outputs the first control signal for turning on the left eye shutter of the goggle 130 and the second control signal for turning on the right eye shutter of the goggle 130, and thus allows the common image to pass through the left eye and right eye shutters.

In other words, the control signal output unit 125 outputs the first control signal, that changes from a high level to a low level at an end time point t2 of a common partial frame PFcom, and the second control signal, that changes from a low level to a high level at a start time point t1 of the common partial frame PFcom. Hence, because the left eye shutter and the right eye shutter are simultaneously open during the common partial frame PFcom, the common image is incident on the left eye and the right eye.

One shutter is not turned off at the time point t2, when the first control signal changes from a high level to a low level, because of a signal delay, and may be turned off after the time point t2. The first control signal may previously change from a high level to a low level during an interval corresponding to a delay time of the signal at the time point t2 so as to remove the signal delay.

One shutter is not turned on at the time point t1, when the second control signal changes from a low level to a high level, because of a signal delay, and may be turned on after the time point t1. The second control signal may previously change from a low level to a high level during an interval corresponding to a delay time of the signal at the time point t1 so as to remove the signal delay.

The foregoing embodiments and advantages are merely exemplary and are not to be construed as limiting the exemplary embodiments. The present teaching can be readily applied to other types of apparatuses. The description of the foregoing exemplary embodiments is intended to be illustrative, and not to limit the scope of the claims. Many alternatives, modifications, and variations will be apparent to those skilled in the art.

1. A plasma display apparatus comprising:
a plasma display panel that displays a left eye image and a right eye image before and after a crosstalk prevention period during a frame;
a first driver that supplies a data signal for the left eye image and the right eye image to the plasma display panel; and
a second driver that supplies a sustain signal to discharge cells of the plasma display panel selected by the supply of the data signal.

2. The plasma display apparatus of claim 1, wherein the crosstalk prevention period is a pause period during which an image is not displayed or a period during which a common image of the left eye image and the right eye image is displayed.

3. The plasma display apparatus of claim 2, further comprising a plurality of phosphors coated on the discharge cells,
wherein a length of the pause period is equal to or smaller than a maximum value of lengths of light hold periods of the phosphors and is equal to or larger than a minimum value of the lengths of the light hold periods of the phosphors.

4. The plasma display apparatus of claim 3, wherein the length of the pause period is equal to or larger than the minimum value of the lengths of the light hold periods of the phosphors and is smaller than 50% of the maximum value of the lengths of the light hold periods of the phosphors.

5. The plasma display apparatus of claim 2, wherein a length of the pause period is 1 ms to 5 ms.

6. The plasma display apparatus of claim 2, wherein the frame includes a first partial frame and a second partial frame that are respectively arranged before and after the pause period or a common partial frame during which the common image is displayed, and the left eye image and the right eye image are respectively displayed during the first partial frame and the second partial frame, wherein in subfields belonging to the first partial frame, a weight value of a subfield of the first partial frame adjacent to the pause period or the common partial frame is smaller than a maximum value of weight values of other subfields except the subfield adjacent to the pause period or the common partial frame.

7. The plasma display apparatus of claim 6, wherein a highest voltage of a reset signal supplied in the subfield of the first partial frame adjacent to the pause period is smaller than highest voltages of reset signals supplied in the other subfields of the first partial frame.

8. The plasma display apparatus of claim 6, wherein the number of setup signals supplied in the first partial frame is different from the number of setup signals supplied in the second partial frame.

9. The plasma display apparatus of claim 6, wherein the plasma display panel displays the left eye image and the right eye image during each of a first frame and a second frame,
wherein the number of setup signals supplied in a first partial frame of the first frame is more than the number of setup signals supplied in a second partial frame of the first frame,
wherein the number of setup signals supplied in a first partial frame of the second frame is less than the number of setup signals supplied in a second partial frame of the second frame.

10. The plasma display apparatus of claim 6, wherein a setup signal and a set-down signal are supplied in at least one of the other subfields except the subfield of the first partial frame adjacent to the pause period.

11. The plasma display apparatus of claim 6, wherein a highest voltage of a reset signal supplied in a subfield of the second partial frame adjacent to the pause period is smaller than highest voltages of reset signals supplied in other subfields except the subfield adjacent to the pause period.

12. The plasma display apparatus of claim 6, wherein the number of sustain signals supplied in the first partial frame is different from the number of sustain signals supplied in the second partial frame.

13. The plasma display apparatus of claim 6, wherein a length of the first partial frame is shorter than a length of the second partial frame.

14. The plasma display apparatus of claim 9, wherein a length of the first partial frame of the first frame is longer than a length of the second partial frame of the first frame, and a length of the first partial frame of the second frame is shorter than a length of the second partial frame of the second frame.

15. The plasma display apparatus of claim 2, wherein the plasma display panel displays the left eye image and the right eye image during each of a first frame and a second frame,
wherein a pause period of the first frame is different from a pause period of the second frame, or a period of the first frame during which the common image is displayed is different from a period of the second frame during which the common image is displayed.

16. The plasma display apparatus of claim 2, wherein the plasma display panel displays the left eye image and the right eye image during each of a first frame and a second frame,
wherein a frame pause period is arranged between the first frame and the second frame.

17. The plasma display apparatus of claim 2, wherein the plasma display panel displays the left eye image and the right eye image during each of a first frame and a second frame,
wherein an average picture level (APL) of the first frame is larger than an APL of the second frame, and a length of a pause period of the first frame is shorter than a length of a pause period of the second frame.

18. The plasma display apparatus of claim 2, wherein the frame includes a first partial frame and a second partial frame that are respectively arranged before and after the pause period or a common partial frame during which the common image is displayed, and the left eye image and the right eye image are respectively displayed during the first partial frame and the second partial frame,
wherein subfields belonging to the first partial frame and subfields belonging to the second partial frame are arranged in decreasing order of weight values.

19. The plasma display apparatus of claim 2, wherein the first driver and the second driver supply a ground level voltage to the plasma display panel during the pause period.

20. The plasma display apparatus of claim 2, further comprising a control signal output unit that outputs a control signal during the pause period, the control signal allowing one of the left eye image or the right eye image to be incident on one eye and then allowing the other image to be incident on the other eye.

21. The plasma display apparatus of claim 2, wherein the frame includes a first partial frame during which one of the left eye image or the right eye image is displayed, a common partial frame during which the common image is displayed, and a second partial frame during which the other of the left eye image or the right eye image is displayed,
wherein another pause period is arranged in at least one of an interval between the first partial frame and the common partial frame or an interval between the second partial frame and the common partial frame.

22. The plasma display apparatus of claim 2, wherein the frame includes a first partial frame during which one of the left eye image or the right eye image is displayed, a common partial frame during which the common image is displayed, and a second partial frame during which the other of the left eye image or the right eye image is displayed,
wherein weight values of subfields belonging to the common partial frame are smaller than a maximum value of weight values of subfields belonging to the first partial frame and a maximum value of weight values of subfields belonging to the second partial frame,
wherein the weight values of the subfields of the common partial frame are equal to or larger than a minimum value of the weight values of the subfields of the first partial frame and a minimum value of the weight values of the subfields of the second partial frame.

23. The plasma display apparatus of claim 2, wherein a data signal of the common image corresponds to a portion of a gray level of a left eye image signal and a portion of a gray level of a right eye image signal.

24. The plasma display apparatus of claim 6, wherein a length of the common partial frame is shorter than a length of the first partial frame and a length of the second partial frame.

25. The plasma display apparatus of claim 6, wherein the number of subfields belonging to the common partial frame are smaller than the number of subfields belonging to the first partial frame and the number of subfields belonging to the second partial frame.

26. A plasma display apparatus comprising:
a plasma display panel that displays a left eye image and a right eye image before and after a crosstalk prevention period during a frame;
a first driver that supplies a data signal for the left eye image and the right eye image to the plasma display panel;
a second driver that supplies a sustain signal to discharge cells of the plasma display panel selected by the supply of the data signal;
a goggle that allows the left eye image and the right eye image to be respectively incident on a left eye and a right eye; and
a control signal output unit that outputs a first control signal for turning on a left eye shutter of the goggle and a second control signal for turning on a right eye shutter of the goggle.

27. The plasma display apparatus of claim 26, wherein the plasma display panel displays a common image of the left eye image and the right eye image during the crosstalk prevention period,
wherein the goggle receives the first control signal and the second control signal from the control signal output unit and allows the common image to be incident on the left eye and the right eye.
